(19) United States
(12) Patent Application Publication
(10) Pub. No.: US 2024/0405497 A1
(43) Pub. Date: Dec. 5, 2024

(54) CHAMBER OF GAS LASER APPARATUS AND ELECTRONIC DEVICE MANUFACTURING METHOD

(71) Applicant: Gigaphoton Inc., Tochigi (JP)

(72) Inventors: Yoichi SASAKI, Oyama-shi (JP); Kouji KAKIZAKI, Oyama-shi (JP); Hiroshi UMEDA, Oyama-shi (JP)

(73) Assignee: Gigaphoton Inc., Tochigi (JP)

(21) Appl. No.: 18/799,444

(22) Filed: Aug. 9, 2024

Related U.S. Application Data
(63) Continuation of application No. PCT/JP2022/011659, filed on Mar. 15, 2022.

(51) Int. Cl. H01S 3/038; H01S 3/034

(52) U.S. Cl. CPC H01S 3/0384; H01S 3/034; H01S 3/0385

(57) ABSTRACT

In a chamber of a gas laser apparatus, a distance from an imaginary axis extending along a predetermined direction to a first end portion between first and second primary electrodes increases from one side toward the other side in the predetermined direction, and a distance from the imaginary axis to a second end portion decreases from the one side toward the other side in the predetermined direction.

### CROSS-REFERENCE TO RELATED APPLICATIONS

The present application is a continuation application of International Application No. PCT/JP2022/011659, filed on Mar. 15, 2022, the entire contents of which are hereby incorporated by reference.

### BACKGROUND

### 1. Technical Field

The present disclosure relates to a chamber of a gas laser apparatus and an electronic device manufacturing method.

### 2. Related Art

In recent years, a semiconductor exposure apparatus is required to improve the resolution thereof as semiconductor integrated circuits are increasingly miniaturized and highly integrated. To this end, reduction in the wavelength of light emitted from a light source for exposure is underway. For example, a KrF excimer laser apparatus, which outputs laser light having a wavelength of about 248 nm, and an ArF excimer laser apparatus, which outputs laser light having a wavelength of about 193 nm, are used as a gas laser apparatus for exposure.

The light from spontaneously oscillating KrF and ArF excimer laser apparatuses has a wide spectral linewidth ranging from 350 pm to 400 pm. A projection lens made of a material that transmits ultraviolet light, such as KrF and ArF laser light, therefore produces chromatic aberrations in some cases. As a result, the resolution of the projection lens may decrease. To avoid the decrease in the resolution, the spectral linewidth of the laser light output from the gas laser apparatus needs to be narrow enough to make the chromatic aberrations negligible. To this end, a line narrowing module (LNM) including a line narrowing element (such as etalon and grating) is provided in some cases in a laser resonator of the gas laser apparatus to narrow the spectral linewidth. A gas laser apparatus providing a narrowed spectral linewidth is hereinafter referred to as a narrowed-line gas laser apparatus.

### CITATION LIST

### Patent Literature

[PTL 1] JP2007-221053A
[PTL 2] JP2004-186310A

### SUMMARY

A chamber of a gas laser apparatus according to an aspect of the present disclosure may be a chamber of a gas laser apparatus that encapsulates a laser gas in an internal space of the chamber and includes first and second primary electrodes that are provided in the internal space, each have a longitudinal direction along a predetermined direction, face each other with a gap therebetween, and cause the laser gas to generate light by using a voltage applied to the electrodes, a window that is provided at a wall surface of the chamber and transmits the light, a first preliminary ionization electrode provided at one side of the first primary electrode, and a second preliminary ionization electrode provided at the one side of the second primary electrode at a position where the second preliminary ionization electrode faces the first preliminary ionization electrode. The first preliminary ionization electrode may include a first dielectric pipe, a first preliminary ionization inner electrode that is disposed inside the first dielectric pipe and extends along a longitudinal direction of the first dielectric pipe, and a first preliminary ionization outer electrode that extends along the longitudinal direction of the first dielectric pipe and includes a first end portion that faces the first dielectric pipe. The second preliminary ionization electrode may include a second dielectric pipe, a second preliminary ionization inner electrode that is disposed inside the second dielectric pipe and extends along a longitudinal direction of the second dielectric pipe, and a second preliminary ionization outer electrode that extends along the longitudinal direction of the second dielectric pipe and includes a second end portion that faces the second dielectric pipe. A distance from an imaginary axis extending along the predetermined direction between the first and second primary electrodes to the first end portion may increase from one side toward another side in the predetermined direction, and a distance from the imaginary axis to the second end portion may decrease from the one side toward the other side in the predetermined direction.

An electronic device manufacturing method according to another aspect of the present disclosure may include generating laser light from a gas laser apparatus having a chamber that encapsulates a laser gas in an internal space thereof, outputting the laser light to an exposure apparatus, and exposing a photosensitive substrate with the laser light in the exposure apparatus to manufacture electronic devices. The chamber may include first and second primary electrodes that are provided in the internal space, each have a longitudinal direction along a predetermined direction, face each other with a gap therebetween, and cause the laser gas to generate light by using a voltage applied to the electrodes, a window that is provided at a wall surface of the chamber and transmits the light, a first preliminary ionization electrode provided at one side of the first primary electrode, and a second preliminary ionization electrode provided at the one side of the second primary electrode at a position where the second preliminary ionization electrode faces the first preliminary ionization electrode. The first preliminary ionization electrode may include a first dielectric pipe, a first preliminary ionization inner electrode that is disposed inside the first dielectric pipe and extends along a longitudinal direction of the first dielectric pipe, and a first preliminary ionization outer electrode that extends along the longitudinal direction of the first dielectric pipe and includes a first end portion that faces the first dielectric pipe. The second preliminary ionization electrode may include a second dielectric pipe, a second preliminary ionization inner electrode that is disposed inside the second dielectric pipe and extends along a longitudinal direction of the second dielectric pipe, and a second preliminary ionization outer electrode that extends along the longitudinal direction of the second dielectric pipe and includes a second end portion that faces the second dielectric pipe. A distance from an imaginary axis extending along the predetermined direction between the first and second primary electrodes to the first end portion may increase from one side toward another side in the predetermined direction, and a distance from the imaginary axis to the second end portion may decrease from the one side toward the other side in the predetermined direction.

### BRIEF DESCRIPTION OF DRAWINGS

Embodiments of the present disclosure will be described below only by way of example with reference to the accompanying drawings.

FIG. 1 is a diagrammatic view showing a schematic configuration example of an entire electronic device manufacturing apparatus.

FIG. 2 is a diagrammatic view showing a schematic configuration example of an entire gas laser apparatus according to Comparative Example.

FIG. 3 is a cross-sectional view of a chamber according to Comparative Example taken along a plane perpendicular to the traveling direction of laser light.

FIG. 4 is a circuit diagram of an electric circuit in the chamber according to Comparative Example.

FIG. 5 shows a preliminary ionization electrode and therearound shown in FIG. 3 as viewed along a Z direction.

FIG. 6 is a top view of an electrode and therearound shown in FIG. 5.

FIG. 7 shows preliminary ionization electrodes and therearound in a first embodiment as viewed along the Z direction.

FIG. 8 is a top view of the preliminary ionization electrodes and therearound shown in FIG. 7.

FIG. 9 is a circuit diagram of an electric circuit in the chamber according to the first embodiment.

FIG. 10 shows the preliminary ionization electrodes and therearound shown in a variation of the first embodiment as viewed along the Z direction.

FIG. 11 shows the preliminary ionization electrodes and therearound shown in

FIG. 10 as viewed along an X direction.

FIG. 12 shows the preliminary ionization electrodes and therearound in a second embodiment as viewed along the Z direction.

FIG. 13 is a top view of the preliminary ionization electrodes and therearound shown in FIG. 12.

FIG. 14 is a circuit diagram of the electric circuit in the chamber according to the second embodiment.

FIG. 15 shows the preliminary ionization electrodes and therearound shown in a variation of the second embodiment as viewed along the Z direction.

FIG. 16 shows the preliminary ionization electrodes and therearound shown in FIG. 15 as viewed along the X direction.

### DETAILED DESCRIPTION

1. Description of electronic device manufacturing apparatus used in electronic device exposure step
2. Description of gas laser apparatus according to Comparative Example
2.1 Configuration
2.2 Operation
2.3 Problems
3. Description of chamber according to first embodiment
3.1 Configuration
3.2 Effects and advantages
4. Description of chamber according to second embodiment
4.1 Configuration
4.2 Effects and advantages

Embodiments of the present disclosure will be described below in detail with reference to the drawings.

The embodiments described below show some examples of the present disclosure and are not intended to limit the contents of the present disclosure. Furthermore, all configurations and operations described in the embodiments are not necessarily essential as configurations and operations in the present disclosure. The same component has the same reference character, and no redundant description of the same component will be made.

### 1. Description of Electronic Device Manufacturing Apparatus Used in Electronic Device Exposure Step

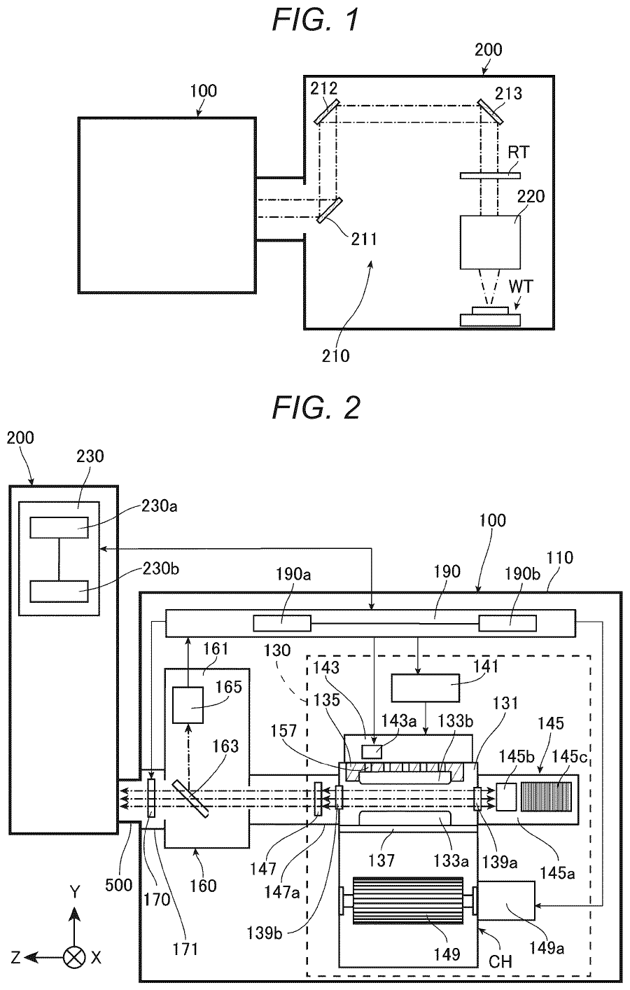

FIG. 1 is a diagrammatic view showing a schematic configuration example of an entire electronic device manufacturing apparatus used in an electronic device exposure step. The manufacturing apparatus used in the exposure step includes a gas laser apparatus 100 and an exposure apparatus 200, as shown in FIG. 1. The exposure apparatus 200 includes an illumination optical system 210, which includes plural mirrors 211, 212, and 213, and a projection optical system 220. The illumination optical system 210 illuminates a reticle pattern on a reticle stage RT with laser light having incident thereon from the gas laser apparatus 100. The projection optical system 220 performs reduction projection on the laser light having passed through the reticle to bring the laser light into focus on a workpiece that is not shown but is placed on a workpiece table WT. The workpiece is a photosensitive substrate onto which a photoresist has been applied, such as a semiconductor wafer. The exposure apparatus 200 translates the reticle stage RT and the workpiece table WT in synchronization with each other to expose the workpiece to the laser light having reflected the reticle pattern. Semiconductor devices that are electronic devices can be manufactured by transferring a device pattern onto the semiconductor wafer in the exposure step described above.

### 2. Description of Gas Laser Apparatus According to Comparative Example

### 2.1 Configuration

The gas laser apparatus 100 according to Comparative Example will be described. Comparative Example in the present disclosure is a form that the applicant is aware of as known only by the applicant, and is not a publicly known example that the applicant is self-aware of.

FIG. 2 is a diagrammatic view showing a schematic configuration example of the entire gas laser apparatus 100 according to Comparative Example. The gas laser apparatus 100 is an ArF excimer laser apparatus using a mixture gas containing, for example, argon (Ar), fluorine (F₂), and neon (Ne). The gas laser apparatus 100 outputs laser light having the center wavelength of about 193 nm. Note that the gas laser apparatus 100 may instead be a gas laser apparatus other than the ArF excimer laser apparatus, for example, a KrF excimer laser apparatus using a mixture gas containing krypton (Kr), F₂, and Ne. In this case, the gas laser apparatus 100 outputs laser light having the center wavelength of about 248 nm. The mixture gas containing Ar, F2, and Ne, which are laser media, and the mixture gas containing Kr, F2, and Ne, which are laser media, are each called a laser gas in some cases.

The gas laser apparatus 100 primarily includes an enclosure 110, a laser oscillator 130, a monitor module 160, a shutter 170, and a laser processor 190, the latter four components of which are disposed in the internal space of the enclosure 110.

The laser oscillator 130 includes a chamber apparatus CH, a charger 141, a pulse power module 143, a line narrowing module 145, and an output coupling mirror 147. FIG. 2 shows the internal configuration of the chamber apparatus CH viewed in a direction substantially perpendicular to the traveling direction of the laser light.

Examples of the material of a chamber 131 of the chamber apparatus CH may include metal such as nickel-plated aluminum and nickel-plated stainless steel. The chamber 131 has an internal space where the laser medium in the laser gas described above is excited to generate light. The light travels to windows 139a and 139b, which will be described later. The laser gas is supplied to the internal space of the chamber 131 from a laser gas supply source that is not shown via a pipe that is not shown. The laser gas in the chamber 131 is caused to flow through a halogen filter that removes the F₂ gas from the laser gas and is otherwise processed, and the removed F₂ gas is exhausted by an exhaust pump that is not shown into the enclosure 110 through a pipe that is not shown.

In the internal space of the chamber 131, an electrode 133a, which is a first primary electrode, and an electrode 133b, which is a second primary electrode, are separate from each other and face each other, and the longitudinal direction of each of the electrodes extends along the traveling direction of the laser light. In the following description, the longitudinal direction of the electrodes 133a and 133b may be referred to as a Z direction, the direction in which the electrodes 133a and 133b are arranged and the direction in which the electrodes 133a and 133b are separate from each other and which is perpendicular to the Z direction may be referred to as a Y direction, and the direction perpendicular to the Y and Z directions may be referred to as an X direction. The electrodes 133a and 133b are discharge electrodes that produce glow discharge to excite the laser medium. In the present example, the electrode 133a is the anode, and the electrode 133b is the cathode.

The electrode 133a is supported by an electrode holder 137 and electrically connected thereto. The electrode 133b is fixed, for example, to a surface of a plate-shaped electrically insulating section 135 that is the surface facing the internal space of the chamber 131 via electrically conductive members 157, which each include a bolt. The electrically conductive members 157 are electrically connected to the pulse power module 143 and apply a high voltage from the pulse power module 143 to the electrode 133b.

The electrically insulating section 135 includes an insulator. Examples of the material of the electrically insulating section 135 may include alumina ceramics, which has low reactivity with F₂ gas. Note that the electrically insulating section 135 only needs to be electrically insulating, and examples of the material of the electrically insulating section 135 may include resin such as phenol resin and fluororesin, quartz, and glass. The electrically insulating section 135 closes an opening provided in the chamber 131 and is fixed to the chamber 131.

The charger 141 is a DC power supply that supplies a predetermined voltage to charge a charging capacitor that is not shown but is provided in the pulse power module 143. The pulse power module 143 includes a switch 143a controlled by the laser processor 190. When the switch 143a is changed from the turned-off state to the turned-on state, the pulse power module 143 generates a high pulse voltage from the electrical energy charged in the charging capacitor and applies the high voltage to the space between the electrodes 133a and 133b.

When the high voltage is applied to the space between the electrodes 133a and 133b, discharge occurs between the electrodes 133a and 133b. The energy of the discharge excites the laser medium in the chamber 131, and the excited laser medium emits light when transitioning to the ground state.

The wall surface of the chamber 131 is provided with the windows 139a and 139b. The window 139a is located at one end of the chamber 131 in the traveling direction of the laser light, and the window 139b is located at the other end in the traveling direction, so that the windows 139a and 139b sandwich the space between the electrodes 133a and 133b. The windows 139a and 139b each incline with respect to the traveling direction of the laser light by Brewster's angle, and therefore suppress reflection of a P-polarized component of the laser light. The laser light as a result of laser oscillation that will be described later exits out of the chamber 131 via the windows 139a and 139b. Since the high pulse voltage is applied to the space between the electrodes 133a and 133b by the pulse power module 143 as described above, the laser light is pulse laser light.

The line narrowing module 145 includes an enclosure 145a, a prism 145b, a grating 145c, and a rotary stage that is not shown, the latter three of which are arranged in the internal space of the enclosure 145a. An opening is formed in the enclosure 145a, and the enclosure 145a is connected to the rear side of the chamber 131 via the opening.

The prism 145b expands the beam width of the light that exits via the window 139a and causes the expanded light to be incident on the grating 145c. Furthermore, the prism 145b reduces the beam width of the light reflected off the grating 145c and causes the resultant light to return into the internal space of the chamber 131 via the window 139a. The prism 145b is supported by the rotary stage and rotated by the rotary stage. The rotation of the prism 145b changes the angle of incidence of the light to be incident on the grating 145c. The rotation of the prism 145b therefore allows selection of a wavelength of the light that returns from the grating 145c to the chamber 131 via the prism 145b. FIG. 2 shows an example in which one prism 145b is disposed, and at least one prism only needs to be disposed.

The surface of the grating 145c is made of a high-reflectance material, and a large number of grooves are provided at the surface at predetermined intervals. The cross-sectional shape of each of the grooves is, for example, a right triangle. When the light incident from the prism 145b on the grating 145c is reflected off the grooves, the light is diffracted in the direction according to the wavelength of the light. The grating 145c is disposed in the Littrow arrangement, which causes the angle of incidence of the light incident from the prism 145b on the grating 145c to be equal to the angle of diffraction of the diffracted light having a desired wavelength. Light having the desired wavelength and wavelengths therearound thus returns to the chamber 131 via the prism 145b.

The output coupling mirror 147 is disposed in the internal space of an optical path tube 147a connected to the front side of the chamber 131, and faces the window 139b. The output coupling mirror 147 transmits part of the laser light that exits via the window 139b toward the monitor module 160, and reflects the other part to cause the light to return into the internal space of the chamber 131 via the window 139b. The grating 145c and the output coupling mirror 147 thus constitute a Fabry-Perot laser resonator, and the chamber 131 is disposed in the optical path of the laser resonator.

The monitor module 160 is disposed in the optical path of the laser light output via the output coupling mirror 147. The monitor module 160 includes an enclosure 161, a beam splitter 163, and a photosensor 165, the latter two components of which are disposed in the internal space of the enclosure 161. An opening is formed in the enclosure 161, and the internal space of the enclosure 161 communicates via the opening with the internal space of the optical path tube 147a.

The beam splitter 163 transmits part of the laser light output via the output coupling mirror 147 toward the shutter 170, and reflects the other part of the laser light toward the light receiving surface of the photosensor 165. The photosensor 165 measures the energy E of the laser light incident on the light receiving surface and outputs a signal representing the measured energy E to the laser processor 190.

The laser processor 190 in the present disclosure is a processing apparatus including a storage 190a, which stores a control program, and a CPU (central processing unit) 190b, which executes the control program. The laser processor 190 is particularly configured or programmed to perform a variety of types of processing described in the present disclosure. The laser processor 190 further controls the entire gas laser apparatus 100.

The laser processor 190 transmits and receives a variety of signals to and from an exposure processor 230 of the exposure apparatus 200. For example, the laser processor 190 receives from the exposure processor 230 signals representing a light emission trigger Tr and target energy Et, which will be described later, and other pieces of information. The target energy Et is a target value of the energy of the laser light used in the exposure process. The laser processor 190 controls a charging voltage applied to the charger 141 based on the energy E received from the photosensor 165 and the target energy Et received from the exposure processor 230. Controlling the charging voltage controls the energy of the laser light. The laser processor 190 transmits a command signal that turns on or off the switch 143a to the pulse power module 143. Furthermore, the laser processor 190 is electrically connected to the shutter 170 and controls opening and closing the shutter 170.

The laser processor 190 closes the shutter 170 until a difference AE between the energy E received from the monitor module 160 and the target energy Et received from the exposure processor 230 falls within an allowable range. When the difference AE falls within the allowable range, the laser processor 190 transmits a reception preparation completion signal indicating that the laser processor 190 is ready to receive the light emission trigger Tr to the exposure processor 230. Upon reception of the reception preparation completion signal, the exposure processor 230 transmits a signal representing the light emission trigger Tr to the laser processor 190, and upon reception of the signal representing the light emission trigger Tr, the laser processor 190 opens the shutter 170. The light emission trigger Tr is a timing signal or an external trigger that is specified by a predetermined repetition frequency f of the laser light and a predetermined number of pulses P thereof, and in response to the light emission trigger Tr, the exposure processor 230 causes the laser oscillator 130 to undergo laser oscillation. The repetition frequency f of the laser light is, for example, higher than or equal to 100 Hz but lower than or equal to 10 KHz.

The shutter 170 is disposed in the optical path of the laser light in the internal space of an optical path tube 171, which communicates with an opening formed at a side of the enclosure 161 of the monitor module 160 that is the opposite side to the side to which the optical path tube 147a is connected. The internal spaces of the optical path tubes 171 and 147a, and the internal spaces of the enclosures 161 and 145a are filled with a purge gas supplied thereto. The purge gas contains an inert gas such as nitrogen (N₂). The purge gas is supplied from a purge gas supply source that is not shown via a pipe that is not shown. The optical path tube 171 communicates with the exposure apparatus 200 through an opening in the enclosure 110 and an optical path tube 500, which connects the enclosure 110 and the exposure apparatus 200 to each other. The laser light having passed through the shutter 170 enters the exposure apparatus 200.

The exposure processor 230 in the present disclosure is a processing apparatus including a storage 230a, which stores a control program, and a CPU 230b, which executes the control program. The exposure processor 230 is particularly configured or programmed to perform a variety of types of processing described in the present disclosure. The exposure processor 230 further controls the entire exposure apparatus 200.

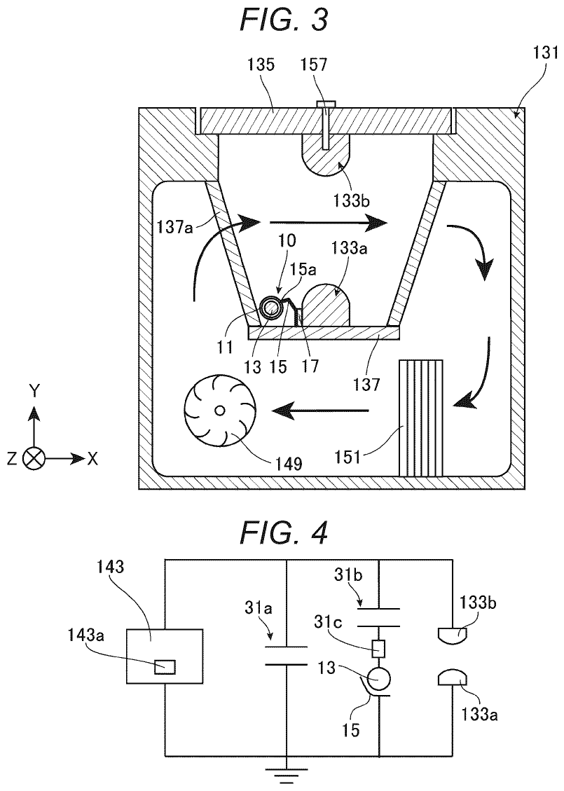

FIG. 3 is a cross-sectional view of the chamber 131 according to Comparative Example taken along a plane perpendicular to the traveling direction of the laser light. A crossflow fan 149 and a heat exchanger 151 are further disposed in the internal space of the chamber 131.

The crossflow fan 149 and the heat exchanger 151 are disposed on the opposite side to the electrode 133a with respect to the electrode holder 137. In the internal space of the chamber 131, the space where the crossflow fan 149 and the heat exchanger 151 are disposed communicates with the space between the electrodes 133a and 133b. The heat exchanger 151 is a radiator that is disposed next to the crossflow fan 149 and connected to a pipe which is not shown but through which a cooling medium in the form of liquid or gas flows. The crossflow fan 149 is connected to a motor 149a disposed outside the chamber 131 as shown in FIG. 2, and rotated by the rotation produced by the motor 149a. As the crossflow fan 149 rotates, the laser gas encapsulated in the internal space of the chamber 131 circulates as indicated by the thick arrows in FIG. 3. That is, the laser gas circulates through the crossflow fan 149, the space between the electrodes 133a and 133b, the heat exchanger 151, and the crossflow fan 149 in this order. At least part of the circulating laser gas passes through the heat exchanger 151, which adjusts the temperature of the laser gas. The circulation of the laser gas moves impurities in the laser gas that have been generated by the primary discharge between the electrodes 133a and 133b downstream, and fresh laser gas is supplied to the space between the electrodes 133a and 133b in the next discharge. When the laser gas passes through the heat exchanger 151, the heat produced in association with the primary discharge is removed, and an increase in the temperature of the laser gas is suppressed. Turning on and off the motor 149a and the rotational speed thereof are controlled by the laser processor 190. The laser processor 190 can therefore adjust the circulation speed of the laser gas circulating in the internal space of the chamber 131 by controlling the motor 149a.

The electrode holder 137 is electrically connected to the chamber 131 via wiring 137a. The electrode 133a supported by the electrode holder 137 is connected to the ground potential via the electrode holder 137, the wiring 137a, and the chamber 131.

On the electrode holder 137, a preliminary ionization electrode 10 is provided on a side of the electrode 133a. The preliminary ionization electrode 10 includes a dielectric pipe 11, a preliminary ionization inner electrode, and a preliminary ionization outer electrode. In the following description, the preliminary ionization inner electrode and the preliminary ionization outer electrode are referred to as an inner electrode 13 and an outer electrode 15, respectively, in some cases.

The dielectric pipe 11 has, for example, a cylindrical shape. Examples of the material of the dielectric pipe 11 may include alumina ceramics and sapphire.

The inner electrode 13 is a rod-shaped electrode, is disposed inside the dielectric pipe 11, and extends along the longitudinal direction of the dielectric pipe 11. Examples of the material of the inner electrode 13 may include copper and brass.

The outer electrode 15 is disposed between the dielectric pipe 11 and the electrode 133a, and extends along the longitudinal direction of the dielectric pipe 11. The outer electrode 15 includes an end portion 15a facing a portion of the outer circumferential surface of the dielectric pipe 11. The end portion 15a is provided across the region from one end to the other end of the outer electrode 15 in the longitudinal direction of the outer electrode 15. The outer electrode 15 is bent in the in-plane direction perpendicular to the longitudinal direction of the dielectric pipe 11, and the bending causes the end portion 15a to be in contact with the outer circumferential surface of the dielectric pipe 11 so as to press the outer circumferential surface of the dielectric pipe 11. Screw holes that are not shown are provided at an end portion of the outer electrode 15 that is the opposite end portion to the end portion 15a, and the outer electrode 15 is fixed to a spacer 17 with screws that are not shown but are screwed into the spacer 17 through the screw holes. The spacer 17 is fixed to the electrode 133a. It can therefore be understood that the outer electrode 15 is fixed to the electrode 133a via the spacer 17. Examples of the material of the outer electrode 15 may include copper and brass.

FIG. 4 is a circuit diagram of an electric circuit in the chamber 131 according to Comparative Example. A peaking capacitor 31a and a preliminary ionization capacitor 31b are further disposed in the chamber 131. The inner electrode 13 is electrically connected to one end of the preliminary ionization capacitor 31b via a current introduction terminal 31c. The outer electrode 15 is electrically connected to the electrode 133a via the electrode holder 137, and also electrically connected to the chamber 131 via the electrode holder 137 and the wiring 137a. The outer electrode 15, the electrode holder 137, the wiring 137a, and the chamber 131 have the ground potential. The pulse power module 143 is electrically connected to the peaking capacitor 31a and the preliminary ionization capacitor 31b so that the charge accumulated in the charging capacitor that is not shown but is provided in the pulse power module 143 is transferred to the peaking capacitor 31a and the preliminary ionization capacitor 31b when the switch 143a of the pulse power module 143 is turned on.

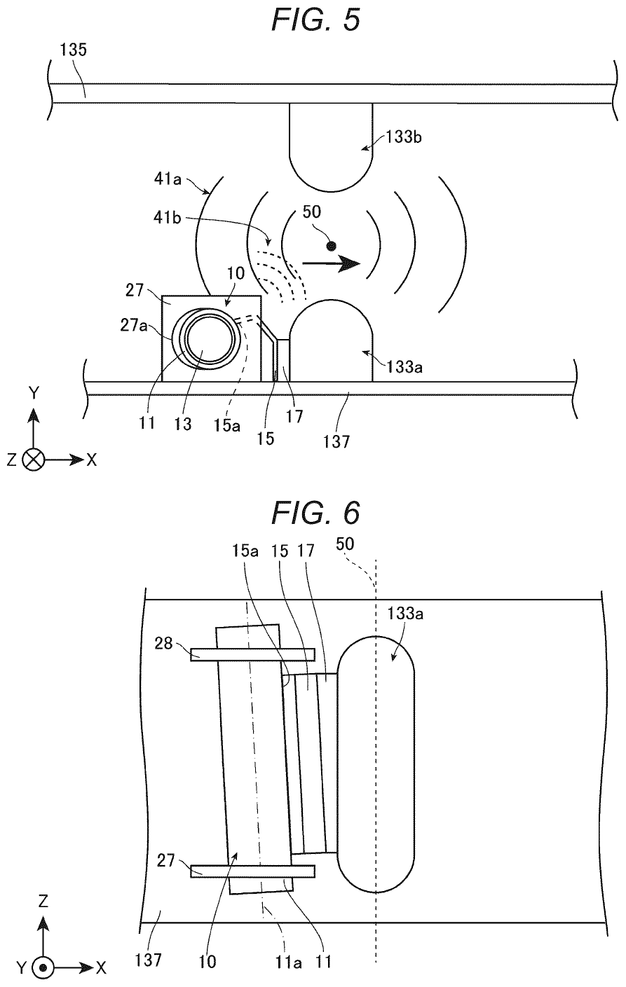

FIG. 5 shows the preliminary ionization electrode 10 and therearound shown in FIG. 3 as viewed along the Z direction, and FIG. 6 is a top view of the electrode 133a and therearound shown in FIG. 5. The thick arrow shown in FIG. 5 indicates the flow of the laser gas.

On the electrode holder 137, a pair of holders 27 and 28 are fixed on a side of the electrode 133a. One end of the dielectric pipe 11 is inserted into a hole 27a of the holder 27, and the other end of the dielectric pipe 11 is inserted into a hole that is not shown but is provided in the holder 28. The dielectric pipe 11 is thus held by the holders 27 and 28.

When the high voltage is applied to the space between the electrodes 133a and 133b, and primary discharge occurs between the electrodes 133a and 133b, an acoustic wave 41a indicated by solid-line curves in FIG. 5 is generated by the primary discharge. The acoustic wave 41a is a compressional wave of the laser gas in the chamber 131, and propagates from the discharge space between the electrodes 133a and 133b while spreading in the chamber 131. The propagation speed of the acoustic wave 41a is approximately 500 m/s.

The acoustic wave 41a is reflected off the internal parts in the chamber 131, such as the outer electrode 15 disposed in the internal space of the chamber 131, and returns as a reflected wave 41b indicated by the broken-line curves in FIG. 5 to the discharge space again. The reflected wave 41b, when returning to the discharge space at the timing when the primary discharge occurs, may affect the performance of the laser light, such as unstable primary discharge and a decrease in the stability of the energy of the laser light output from the gas laser apparatus 100. The degree of the effect described above tends to increase when the repetition frequency of the laser light is equal to or higher than 2 kHz.

In the gas laser apparatus 100 according to Comparative Example, to suppress the effect of the acoustic wave 41a on the performance of the laser light, the longitudinal directions of the dielectric pipe 11 and the outer electrode 15 each incline with respect to an imaginary axis 50, which will be described later, when viewed along the Y direction. To facilitate understanding of the inclination described above, FIG. 6 shows a center axis 11a of the dielectric pipe 11, which inclines with respect to the imaginary axis 50, by way of example. The imaginary axis 50 is an axis extending in the Z direction between the electrodes 133a and 133b. Furthermore, the imaginary axis 50 is located in the middle of the space between the electrodes 133a and 133b, and coincides with the center axis of the electrode 133a when viewed along the Y direction. The inclination described above causes the distance from the imaginary axis 50 to the end portion 15a of the outer electrode 15 to increase as the outer electrode 15 extends from one end toward the other end in the Z direction. The one end in the Z direction faces the line narrowing module 145, and the other end faces the monitor module 160. The description has been made with reference to the end portion 15a, and the same applies to the dielectric pipe 11 and the outer electrode 15. The inclination described above causes, for example, the length of the propagation path of the reflected wave 41b reflected off the outer electrode 15 and returning to the discharge space to change in accordance with the position in the Z direction. The change described above shifts the phase of the reflected wave 41b returning to the discharge space to prevent the reflected wave 41b from returning to the discharge space at the timing when the primary discharge occurs, so that the effect of the acoustic wave 41a on the performance of the laser light is suppressed. That is, unstable primary discharge is suppressed, so that a decrease in the stability of the energy of the laser light output from the gas laser apparatus 100 is suppressed.

### 2.2 Operation

The operation of the gas laser apparatus 100 according to Comparative Example will next be described.

In the state before the gas laser apparatus 100 outputs the laser light, the internal spaces of the optical path tubes 147a, 171, and 500 and the internal spaces of the enclosures 145a and 161 are filled with the purge gas from the purge gas supply source, which is not shown. The laser gas is supplied from the laser gas supply source, which is not shown, into the internal space of the chamber 131. When the laser gas is supplied, the laser processor 190 controls the motor 149a to rotate the crossflow fan 149. The rotation of the crossflow fan 149 causes the laser gas to circulate in the interior space of the chamber 131.

When the gas laser apparatus 100 outputs the laser light, the laser processor 190 receives the signal representing the target energy Et and the signal representing the light emission trigger Tr from the exposure processor 230. The laser processor 190 then sets the charging voltage to be output from the charger 141 in such a way that the difference AE between the energy E of the laser light and the target energy Et falls within the allowable range. The laser processor 190 turns on the switch 143a of the pulse power module 143. The pulse power module 143 thus applies the high pulse voltage derived from the electrical energy charged in the charging capacitor, which is not shown, to the space between the electrodes 133a and 133b and the space between the inner electrode 13 and the outer electrode 15. When the high voltage is applied to the space between the inner electrode 13 and the outer electrode 15, corona discharge occurs in the vicinity of the dielectric pipe 11 and the end portion 15a, and ultraviolet light is radiated. When the laser gas between the electrodes 133a and 133b is irradiated with the ultraviolet light, the laser gas between the electrodes 133a and 133b is preliminarily ionized. After the preliminary ionization, when the voltage between the electrodes 133a and 133b reaches the breakdown voltage, primary discharge occurs between the electrodes 133a and 133b. As a result, an excimer is generated from the laser medium contained in the laser gas between the electrodes 133a and 133b, and emits light when dissociated. The light resonates between the grating 145c and the output coupling mirror 147, and the light is amplified whenever passing through the discharge space in the internal space of the chamber 131, resulting in laser oscillation. Part of the laser light then passes as the pulse laser light through the output coupling mirror 147 and travels to the beam splitter 163.

Part of the laser light having traveled to the beam splitter 163 is reflected off the beam splitter 163 and received by the photosensor 165. The photosensor 165 measures the energy E of the received laser light and outputs the signal representing the energy E to the laser processor 190. The laser processor 190 controls the charging voltage in such a way that the difference AE between the energy E and the target energy Et falls within the allowable range.

The acoustic wave 41a is generated by the primary discharge between the electrodes 133a and 133b, but the longitudinal directions of the dielectric pipe 11 and the outer electrode 15 each incline with respect to the imaginary axis 50. The inclination shifts the phase of the reflected wave 41b returning to the discharge space, so that a decrease in the stability of the energy of the laser light output from the gas laser apparatus 100 is suppressed, as described above.

### 2.3 Problems

In the gas laser apparatus 100 according to Comparative Example, to suppress the effect of the acoustic wave 41a on the performance of the laser light, the longitudinal directions of the dielectric pipe 11 and the outer electrode 15 each incline with respect to the imaginary axis 50, so that the distance from the imaginary axis 50 to the end portion 15a increases as the outer electrode 15 extends from the one end toward the other end in the Z direction. The ultraviolet light generated in the vicinity of the dielectric pipe 11 and the end portion 15a tends to attenuate as the distance increases as described above in accordance with the Lambert-Beer law. The intensity of the preliminary ionization caused by the preliminary ionization electrode 10 at the imaginary axis 50 may therefore become nonuniform in the axial direction of the imaginary axis 50. Specifically, the preliminary ionization intensity may decrease from the one end facing the line narrowing module 145 toward the other end facing the monitor module 160. When the preliminary ionization intensity becomes nonuniform, unstable primary discharge may occur, and the stability of the energy of the laser light output from the gas laser apparatus 100 may decrease. There is therefore a concern that the exposure apparatus 200 does not output laser light that satisfies required performance, and that the reliability of the gas laser apparatus 100 therefore deteriorates.

To eliminate the concern described above, a chamber 131 of the gas laser apparatus 100 that can suppress the decrease in the reliability thereof is shown by way of example in the following embodiment.

### 3. Description of Chamber According to First Embodiment

The chamber 131 according to the present embodiment will next be described. The same components as those described above have the same reference characters, and no duplicate description of the same components will be made unless otherwise particularly described. In some drawings, some members may be omitted or simplified in some cases for clarity.

### 3.1 Configuration

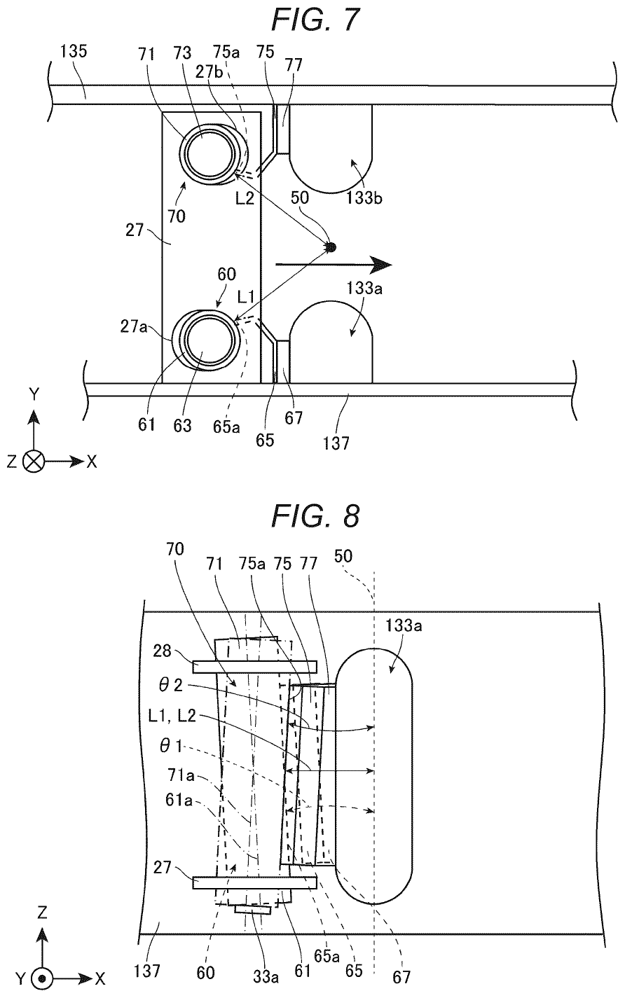

FIG. 7 shows the preliminary ionization electrode and therearound in the present embodiment as viewed along the Z direction, and FIG. 8 is a top view of the preliminary ionization electrode and therearound shown in FIG. 7. The electrode 133b and the electrically insulating section 135 are omitted in FIG. 8 for clarity.

The chamber 131 according to the present embodiment differs from that according to Comparative Example in that one preliminary ionization electrode is added to the preliminary ionization electrode in Comparative Example. In the description below, the two preliminary ionization electrodes will be described as a first preliminary ionization electrode and a second preliminary ionization electrode for convenience of the description. Note in some cases that the first preliminary ionization electrode is called a preliminary ionization electrode 60, and that the second preliminary ionization electrode is called a preliminary ionization electrode 70. The preliminary ionization electrode 60 corresponds to the preliminary ionization electrode 10 in Comparative Example, merely with a different reference character. The preliminary ionization electrode 70 is configured the same as the preliminary ionization electrode 10.

For convenience of the following description, the dielectric pipe, the preliminary ionization inner electrode, the preliminary ionization outer electrode, and the end section of the preliminary ionization electrode 60 are referred to as a first dielectric pipe, a first preliminary ionization inner electrode, a first preliminary ionization outer electrode, and a first end portion. In the following description, the components of the preliminary ionization electrode 60 are called a dielectric pipe 61, an inner electrode 63, an outer electrode 65, and a first end portion 65a in some cases. Similarly, the dielectric pipe, the preliminary ionization inner electrode, the preliminary ionization outer electrode, and the end portion of the preliminary ionization electrode 70 are referred to as a second dielectric pipe, a second preliminary ionization inner electrode, a second preliminary ionization outer electrode, and a second end portion. In the following description, the components of the preliminary ionization electrode 70 are called a dielectric pipe 71, an inner electrode 73, an outer electrode 75, and a second end portion 75a in some cases.

The preliminary ionization electrode 60 is provided on one side of the electrode 133a in the X direction, and the preliminary ionization electrode 70 is provided at a position on the one side of the electrode 133b where the preliminary ionization electrode 70 faces the preliminary ionization electrode 60. In FIG. 8, portions of the dielectric pipe 61, the first end portion 65a, and the outer electrode 65 that are the portions that overlap with the dielectric pipe 71, the second end portion 75a, and the outer electrode 75 are indicated by broken lines. The preliminary ionization electrodes 60 and 70 are disposed upstream in the laser gas flowing in the X direction between the electrodes 133a and 133b. FIG. 7 shows the flow of laser gas with the thick arrow.

In the preliminary ionization electrodes 60 and 70, the longitudinal directions of the dielectric pipes 61 and 71 incline toward opposite orientations in the X direction with respect to the imaginary axis 50 so that the dielectric pipes 61 and 71 intersect with each other when viewed along the Y direction. To facilitate understanding of the inclination described above, FIG. 8 shows center axes 61a and 71a of the dielectric pipes 61 and 71.

The inclination of the dielectric pipes 61 and 71 also causes the directions in which the outer electrodes 65 and 75 and the end portions 65a and 75a extend to incline with respect to the imaginary axis 50. The length of the first end portion 65a is equal to that of the second end portion 75a, and when viewed along the Y direction, the center of the first end portion 65a in the longitudinal direction of the outer electrode 65 coincides with the center of the second end portion 75a in the longitudinal direction of the outer electrode 75. The first end portion 65a inclines counterclockwise with respect to the imaginary axis 50 around the center of the first end portion 65a, and the second end portion 75a inclines clockwise with respect to the imaginary axis 50 around the center of the second end portion 75a. Therefore, when viewed along the Y direction, the distance from the imaginary axis 50 to the first end portion 65a increases as the outer electrode 65 extends from one end toward the other end in the Z direction. Furthermore, when viewed along the Y direction, the distance from the imaginary axis 50 to the second end portion 75a decreases as the outer electrode 75 extends from the one end toward the other end in the Z direction. The one end in the Z direction faces the line narrowing module 145, and the other end faces the monitor module 160. Note that when viewed along the X direction, the first end portion 65a and the second end portion 75a are disposed in parallel to each other.

When viewed along the Y direction, the direction in which the first end portion 65a extends inclines by a first angle θ1 with respect to the imaginary axis 50, and the direction in which the second end portion 75a extends inclines by a second angle θ2, which is equal to the first angle θ1, with respect to the imaginary axis 50 in the opposite orientation to the inclination of the direction in which the first end portion 65a extends. The first end portion 65a and the second end portion 75a are therefore symmetrically disposed with respect to the center of the first end portion 65a. Furthermore, the direction in which the first end portion 65a extends inclines with respect to the imaginary axis 50 by the same angle by which the direction in which the second end portion 75a extends inclines with respect to the imaginary axis 50 in the opposite orientation to the inclination of the direction in which the second end portion 75a extends. The angles θ1 and θ2 are each an acute angle greater than or equal to 0.2 degrees but smaller than or equal to 3.0 degrees. Note that the first end portion 65a and the second end portion 75a may be disposed asymmetrically with respect to the center of the first end portion 65a, and the angles θ1 and θ2 may differ from each other.

Furthermore, it is preferable that a first distance LI from the center of the first end portion 65a in the longitudinal direction of the outer electrode 65 to the imaginary axis 50 is equal to a second distance L2 from the center of the second end portion 75a in the longitudinal direction of the outer electrode 75 to the imaginary axis 50. Note that when the first distance L1 and the second distance L2 differ from each other, it is preferable that one of the distances is greater than or equal to 0.9 times the other but smaller than or equal to 1.1 times the other.

The above description has been made with reference to the end portions 65a and 75a, and the dielectric pipes 61 and 71, the inner electrodes 63 and 73, and the outer electrodes 65 and 75 also incline the same as the end portions 65a and 75a.

The outer electrode 65 is fixed to a first spacer 67, which corresponds to the spacer 17 in Comparative Example, in the same manner as in Comparative Example. The outer electrode 65 is therefore fixed to the electrode 133a via the first spacer 67. Note that the outer electrode 65 may be directly fixed to the electrode 133a. A second spacer 77, which is configured the same as the spacer 17 in Comparative Example and fixed to the electrode 133b, is disposed at a surface of the electrically insulating section 135 in the present embodiment that is the surface facing the inner space of the chamber 131. The outer electrode 75 is fixed to the second spacer 77, as the outer electrode 15 is fixed to the spacer 17. The outer electrode 75 is therefore fixed to the electrode 133b via the second spacer 77. Note that the outer electrode 75 may be directly fixed to the electrode 133b.

The holder 27 in the present embodiment extends in the Y direction and includes two holes 27a and 27b separate from each other in the Y direction. One end of the dielectric pipe 61 is inserted into the hole 27a on the side facing the electrode holder 137, and one end of the dielectric pipe 71 is inserted into the hole 27b on the side facing the electrically insulating section 135. The one end of each of the dielectric pipes 61 and 71 is thus held by the holder 27. The holder 28 in the present embodiment is configured the same as the holder 27 in the present embodiment, the other end of the dielectric pipe 61 is inserted into a hole, on the side facing the electrode holder 137, in the holder 28 that is not shown, and the other end of the dielectric pipe 71 is inserted into a hole, on the side facing the electrically insulating section 135, in the holder 28 that is not shown. The other end of each of the dielectric pipes 61 and 71 is thus held by the holder 28.

Ends of the inner electrodes 63 and 73 that are the ends on one side are electrically connected to each other via an inner electrode connector 33a. Note that the other ends of the inner electrodes 63 and 73 may also be electrically connected to each other via another inner electrode connector 33a. The inner electrode connector 33a has a columnar shape, but may be a wire-shaped connector. The inner electrode 73 is connected to the pulse power module 143 via wiring that is not shown. The other end of the outer electrode 75 is electrically connected to the electrode 133b.

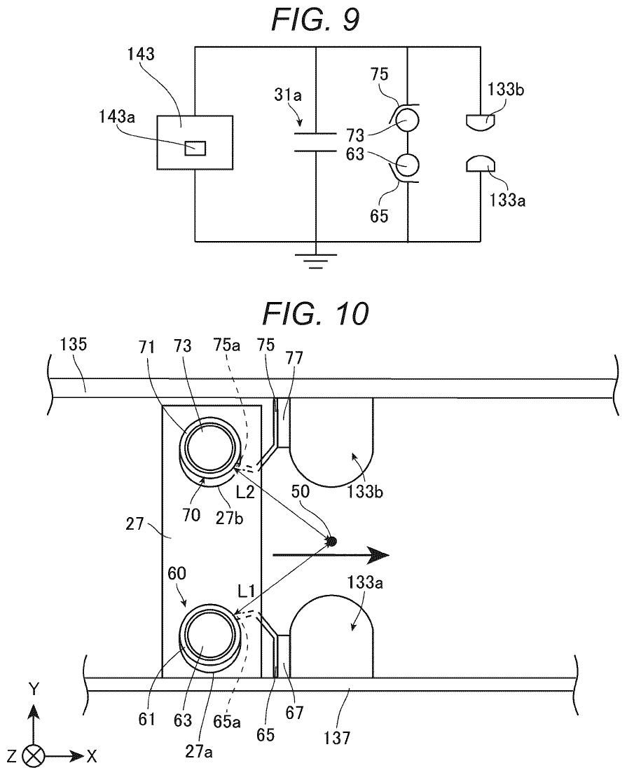

FIG. 9 is a circuit diagram of an electric circuit in the chamber 131 according to the present embodiment. The electrical circuit diagram in the present embodiment differs from the electrical circuit diagram in Comparative Example in that the preliminary ionization capacitor 31b or the current introduction terminal 31c is not disposed. When the switch 143a is turned on, the charge accumulated in the charging capacitor is transferred to the peaking capacitor 31a, and at the same time, the voltage between the electrodes 133a and 133b increases. Furthermore, a voltage that is half the voltage across the space between the electrodes 133a and 133b is induced across each of the inner electrodes 63 and 73. Corona discharge therefore occurs in the vicinity of the dielectric pipe 61 and the first end portion 65a and in the vicinity of the dielectric pipe 71 and the second end portion 75a, so that ultraviolet light is radiated from each of the regions where the corona discharge occurs. When the laser gas between the electrodes 133a and 133b is irradiated with the ultraviolet light, the laser gas between the electrodes 133a and 133b is preliminarily ionized. After the preliminary ionization, when the voltage between the electrodes 133a and 133b reaches the breakdown voltage, primary discharge occurs between the electrodes 133a and 133b. As a result, an excimer is generated from the laser medium contained in the laser gas between the electrodes 133a and 133b, and emits light when dissociated.

### 3.2 Effects and Advantages

In the chamber 131 according to the present embodiment, the distance from the imaginary axis 50 to the first end portion 65a increases as the outer electrode 65 extends from one end toward the other end in the Z direction. Furthermore, the distance from the imaginary axis 50 to the second end portion 75a decreases as the outer electrode 75 extends from the one end toward the other end in the Z direction.

In the preliminary ionization electrodes 60 and 70, when a high voltage is applied to the space between the inner electrode 63 and the outer electrode 65 and the space between the inner electrode 73 and the outer electrode 75, corona discharge occurs in the vicinity of the dielectric pipe 61 and the first end portion 65a and in the vicinity of the dielectric pipe 71 and the second end portion 75a, so that ultraviolet light is radiated. When the laser gas between the electrodes 133a and 133b is irradiated with the ultraviolet light, the laser gas between the electrodes 133a and 133b is preliminarily ionized. After the preliminary ionization, when the voltage between the electrodes 133a and 133b reaches the breakdown voltage, primary discharge occurs between the electrodes 133a and 133b. In the configuration described above, since the distance from the imaginary axis 50 to the first end portion 65a increases as the outer electrode 65 extends from one end toward the other end in the Z direction, the intensity of the preliminary ionization at the imaginary axis 50 caused by the preliminary ionization electrode 60 decreases as the outer electrode 65 extends from the one end toward the other end in the Z direction. Furthermore, since the distance from the imaginary axis 50 to the second end portion 75a decreases as the outer electrode 75 extends from the one end toward the other end in the Z direction, the intensity of the preliminary ionization at the imaginary axis 50 caused by the preliminary ionization electrode 70 increases as the outer electrode 75 extends from the one end toward the other end in the Z direction. At the imaginary axis 50, the intensity of the preliminary ionization caused by the preliminary ionization electrode 60, which decreases as the outer electrode 65 extends from the one end toward the other end in the Z direction, and the intensity of the preliminary ionization caused by the preliminary ionization electrode 70, which increases as the outer electrode 75 extends from the one end toward the other end in the Z direction, are combined with each other, so that nonuniformity in the preliminary ionization intensity can be suppressed. Unstable primary discharge is thus suppressed, so that a decrease in the stability of the energy of the laser light output from the gas laser apparatus 100 can be suppressed. Therefore, the exposure apparatus 200 can output laser light that satisfies required performance, and deterioration of the reliability of the gas laser apparatus 100 can be suppressed.

In the chamber 131, the preliminary ionization electrodes 60 and 70 are disposed upstream in the laser gas flowing between the electrodes 133a and 133b.

When primary discharge occurs between the electrodes 133a and 133b, discharge products, such as positive ions, negative ions, and metal fluoride, are produced. The laser gas flowing between the electrodes 133a and 133b causes the discharge products to flow. When the preliminary ionization electrodes 60 and 70 are disposed downstream in the flow of the laser gas, the discharge products caused to flow by the laser gas may absorb the ultraviolet light emitted from each of the preliminary ionization electrodes 60 and 70. Radiation of the ultraviolet light to the laser gas between the electrodes 133a and 133b may thus be suppressed. In the configuration in the present embodiment, however, the preliminary ionization electrodes 60 and 70 are disposed upstream in the flow of the laser gas, so that the absorption of the ultraviolet light by the discharge products can be suppressed. The unstable primary discharge is therefore suppressed, so that a decrease in the stability of the energy of the laser light output from the gas laser apparatus 100 is suppressed. Note that the preliminary ionization electrodes 60 and 70 may be shifted from the electrodes 133a and 133b to positions downstream in the laser gas flowing between the electrodes 133a and 133b.

Furthermore, in the chamber 131, the direction in which the first end portion 65a extends inclines with respect to the imaginary axis 50 by the same angle by which the direction in which the second end portion 75a extends inclines in the opposite orientation to the inclination of the direction in which the second end portion 75a extends, and the first distance L1 is equal to the second distance L2.

In the configuration described above, when viewed along the Y direction, the first end portion 65a and the second end portion 75a are disposed symmetrically with respect to the respective centers thereof, and when viewed along the X direction, the first end portion 65a and the second end portion 75a are disposed in parallel to each other. The nonuniformity in the preliminary ionization intensity at the imaginary axis 50 can therefore be further suppressed, so that a decrease in the stability of the energy of the laser light output from the gas laser apparatus 100 can be further suppressed.

Note that the first end portion 65a may incline clockwise and the second end portion 75a may incline counterclockwise in the chamber 131. In this case, the distance from the imaginary axis 50 to the first end portion 65a decreases as the outer electrode 65 extends from the one end toward the other end in the Z direction. The distance from the imaginary axis 50 to the second end portion 75a increases as the outer electrode 75 extends from the one end toward the other end in the Z direction.

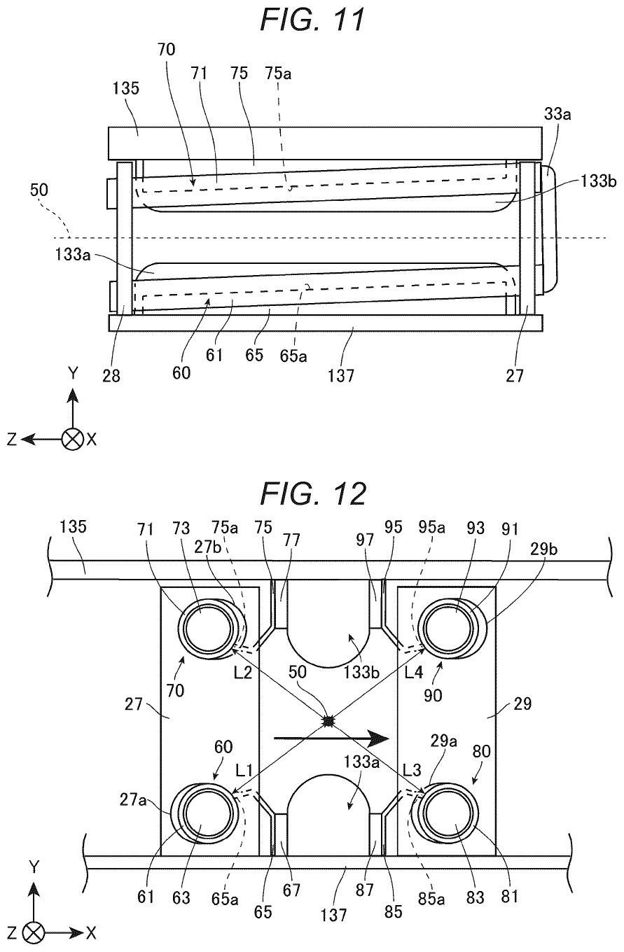

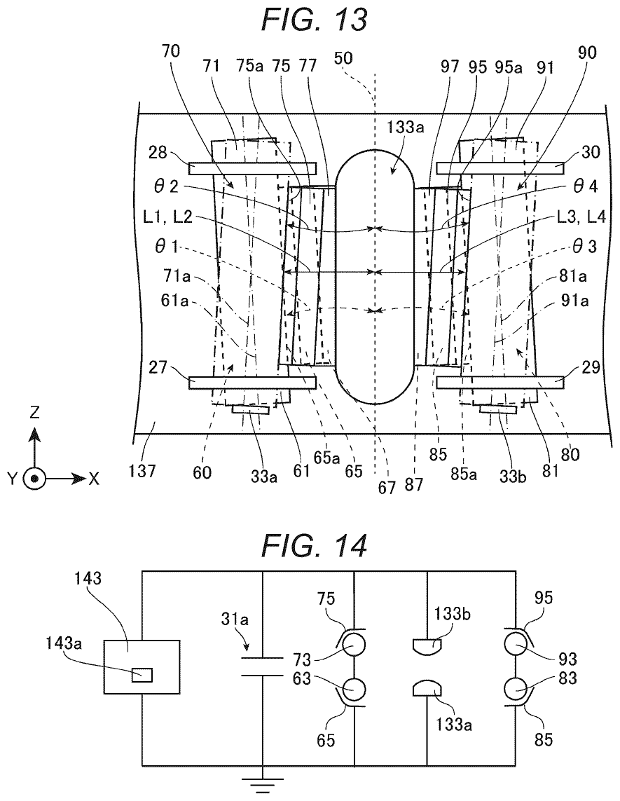

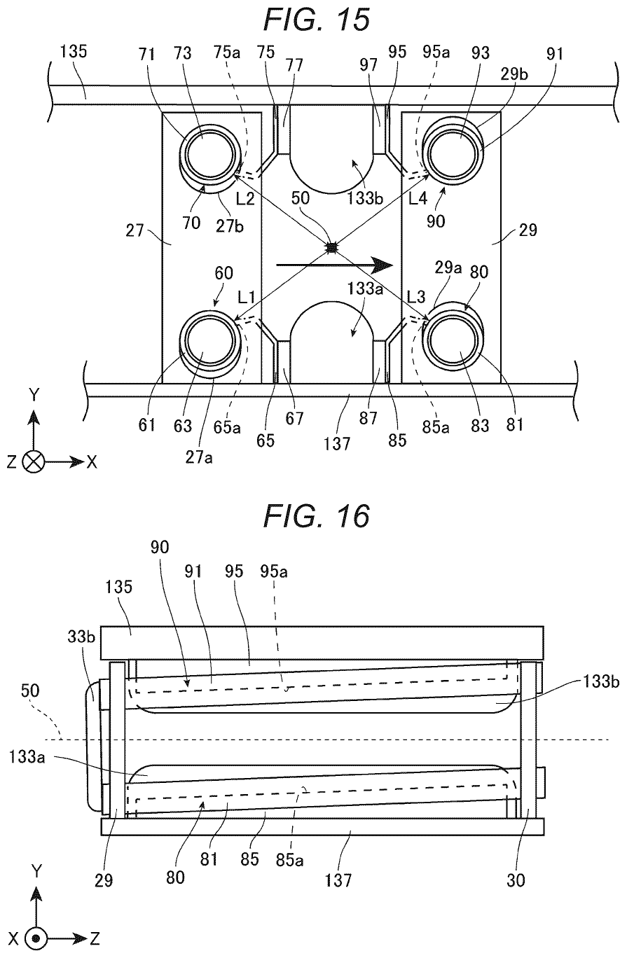

FIG. 10 shows the preliminary ionization electrodes 60 and 70 and therearound shown in a variation of the present embodiment as viewed along the Z direction, and FIG. 11 shows the preliminary ionization electrodes 60 and 70 and therearound shown in FIG. 10 as viewed along the X direction.

In the present variation, the orientations of the inclination of the first end portion 65a and the second end portion 75a differ from those in the first embodiment. When viewed along the Y direction, the dielectric pipe 61, the outer electrode 65, and the first end portion 65a coincide with the dielectric pipe 71, the outer electrode 75, and the second end portion 75a, and are not shifted therefrom. Furthermore, in the present variation, the direction in which the first end portion 65a extends and the direction in which the second end portion 75a extends incline toward the same side in the Y direction with respect to the imaginary axis 50 when viewed along the X direction. Specifically, the first end portion 65a separates away from the imaginary axis 50 as extending from one end toward the other end in the Z direction, and the second end portion 75a approaches the imaginary axis 50 as extending from the one end toward the other end in the Z direction. The thus disposed first end portion 65a and second end portion 75a extend in parallel to each other. The distance from the imaginary axis 50 to the first end portion 65a therefore increases as the outer electrode 65 extends from the one end toward the other end in the Z direction. Furthermore, the distance from the imaginary axis 50 to the second end portion 75a decreases as the outer electrode 75 extends from the one end toward the other end in the Z direction.

According to the configuration described above, nonuniformity in the intensity of the preliminary ionization at the imaginary axis 50 can be further suppressed as compared with the case where the direction in which the first end portion 65a extends is not parallel to the direction in which the second end portion 75a extends when viewed along the X direction, so that a decrease in the stability of the energy of the laser light output from the gas laser apparatus 100 can be further suppressed. Note that when viewed along the X direction, the first end portion 65a may not be parallel to the second end portion 75a. Furthermore, when viewed along the Y direction, the direction in which the first end portion 65a extends may deviate from the direction in which the second end portion 75a extends.

### 4. Description of Chamber According to Second Embodiment

The chamber 131 according to the present embodiment will next be described. The same components as those described above have the same reference characters, and no duplicate description of the same components will be made unless otherwise particularly described.

### 4.1 Configuration

FIG. 12 shows the preliminary ionization electrodes 60 and 70 and therearound in the present embodiment as viewed along the Z direction, and FIG. 13 is a top view of the preliminary ionization electrodes 60 and 70 and therearound shown in FIG. 12. FIG. 13 does not show the electrode 133b or the electrically insulating section 135 for clarity.

The chamber 131 according to the present embodiment differs from the chamber according to the first embodiment in that two preliminary ionization electrodes are further added to the chamber in the first embodiment. The two added preliminary ionization electrodes will be described as a third preliminary ionization electrode and a fourth preliminary ionization electrode for convenience of the description. Note in some cases that the third preliminary ionization electrode is called a preliminary ionization electrode 80, and that the fourth preliminary ionization electrode is called a preliminary ionization electrode 90.

The preliminary ionization electrodes 80 and 90 are each configured the same as the preliminary ionization electrode 10 in Comparative Example, the preliminary ionization electrode 80 is disposed at a side of the electrode 133a, and the preliminary ionization electrode 90 is disposed at a side of the electrode 133b.

For convenience of the description, the dielectric pipe, the preliminary ionization inner electrode, the preliminary ionization outer electrode, and the end portion of the preliminary ionization electrode 80 are referred to as a third dielectric pipe, a third preliminary ionization inner electrode, a third preliminary ionization outer electrode, and a third end portion. In the following description, the components of the preliminary ionization electrode 80 are called a dielectric pipe 81, an inner electrode 83, an outer electrode 85, and a third end portion 85a in some cases. Similarly, the dielectric pipe, the preliminary ionization inner electrode, the preliminary ionization outer electrode, and the end portion of the preliminary ionization electrode 90 are referred to as a fourth dielectric pipe, a fourth preliminary ionization inner electrode, a fourth preliminary ionization outer electrode, and a fourth end portion. In the following description, the components of the preliminary ionization electrode 90 are called a dielectric pipe 91, an inner electrode 93, an outer electrode 95, and a fourth end portion 95a in some cases.

The preliminary ionization electrode 80 is provided on the other side of the electrode 133a in the X direction, that is, on the opposite side to the preliminary ionization electrode 60. The preliminary ionization electrode 90 is provided on the other side of the electrode 133b, that is, at a position where the preliminary ionization electrode 90 faces the preliminary ionization electrode 80 on the opposite side to the preliminary ionization electrode 70. In FIG. 13, portions of the dielectric pipe 81, the third end portion 85a, and the outer electrode 85 that are the portions that overlap with the dielectric pipe 91, the fourth end portion 95a, and the outer electrode 95 are indicated by the broken lines. The preliminary ionization electrodes 80 and 90 are disposed downstream in the laser gas flowing in the X direction between the electrode 133a and the electrode 133b. FIG. 12 shows the flow of laser gas with the thick arrow.

The dielectric pipe 81 is parallel to the dielectric pipe 61, and the dielectric pipe 91 is parallel to the dielectric pipe 71. The longitudinal directions of the dielectric pipes 81 and 91 incline toward opposite orientations in the X direction with respect to the imaginary axis 50 so that the dielectric pipes 81 and 91 intersect with each other when viewed along the Y direction. To facilitate understanding of the inclination described above, FIG. 13 shows center axes 81a and 91a of the dielectric pipes 81 and 91. The directions in which the end portions 85a and 95a extend therefore also incline in the same manner as the directions in which the end portions 65a and 75a extend incline. When viewed along the Y direction, the center of the third end portion 85a in the longitudinal direction of the outer electrode 85 coincides with the center of the fourth end portion 95a in the longitudinal direction of the outer electrode 95. The third end portion 85a inclines counterclockwise with respect to the imaginary axis 50 around the center of the third end portion 85a, and the fourth end portion 95a inclines clockwise with respect to the imaginary axis 50 around the center of the fourth end portion 95a. Therefore, when viewed along the Y direction, the distance from the imaginary axis 50 to the third end portion 85a decreases as the outer electrode 85 extends from one end toward the other end in the Z direction. Furthermore, when viewed along the Y direction, the distance from the imaginary axis 50 to the fourth end portion 95a increases as the outer electrode 95 extends from the one end toward the other end in the Z direction. Note that when viewed along the X direction, the third end portion 85a and the fourth end portion 95a are disposed in parallel to each other.

When viewed along the Y direction, the direction in which the third end portion 85a extends inclines by a third angle θ3 with respect to the imaginary axis 50, and the direction in which the fourth end portion 95a extends inclines by a fourth angle θ4, which is equal to the third angle θ3, with respect to the imaginary axis 50 in the opposite orientation to the inclination of the direction in which the third end portion 85a extends. The third end portion 85a and the fourth end portion 95a are therefore symmetrically disposed with respect to the center of the third end portion 85a. Furthermore, the direction in which the third end portion 85a extends inclines with respect to the imaginary axis 50 by the same angle by which the direction in which the fourth end portion 95a extends inclines in the opposite orientation to the inclination of the direction in which the fourth end portion 95a extends. The angles θ3 and θ4 are each an acute angle greater than or equal to 0.2 degrees but smaller than or equal to 3.0 degrees. The dielectric pipe 81 is parallel to the dielectric pipe 61, and the dielectric pipe 91 is parallel to the dielectric pipe 71, as described above. Therefore, the direction in which the third end portion 85a extends is parallel to the direction in which the first end portion 65a extends, the direction in which the fourth end portion 95a extends is parallel to the direction in which the second end portion 75a extends, the third angle θ3 is equal to the first angle θ1, and the fourth angle θ4 is equal to the second angle θ2. Note that the third end portion 85a and the fourth end portion 95a may be disposed asymmetrically with respect to the center of the third end portion 85a, and the angles θ3 and θ4 may differ from each other. Furthermore, the third angle θ3 may differ from the first angle θ1, and the fourth angle θ4 may differ from the second angle θ2.

Furthermore, it is preferable that a third distance L3 in the X direction from the center of the third end portion 85a in the longitudinal direction of the outer electrode 85 to the imaginary axis 50 is equal to a fourth distance L4 in the X direction from the center of the fourth end portion 95a in the longitudinal direction of the outer electrode 95 to the imaginary axis 50. Note that when the third distance L3 and the fourth distance L4 differ from each other, it is preferable that one of the distances is greater than or equal to 0.9 times the other but smaller than or equal to 1.1 times the other. Moreover, it is preferable that the third distance L3 is equal to the first distance L1, and that the fourth distance L4 is equal to the second distance L2.

The above description has been made with reference to the end portions 85a and 95a, and the dielectric pipes 81 and 91, the inner electrodes 83 and 93, and the outer electrodes 85 and 95 also incline the same as the end portions 85a and 95a.

The electrode holder 137 in the present embodiment is provided with a third spacer 87 configured the same as the first spacer 67 and fixed to the electrode 133a. A fourth spacer 97, which is configured the same as the second spacer 77 and fixed to the electrode 133b, is provided at a surface of the electrically insulating section 135 that is the surface facing the internal space of the chamber 131. The outer electrodes 85 and 95 are separately fixed to the spacers 87 and 97 in the same manner as the outer electrodes 65 and 75 are fixed to the spacers 67 and 77. Therefore, the outer electrode 85 is fixed to the electrode 133a via the third spacer 87, and the outer electrode 95 is fixed to the electrode 133b via the fourth spacer 97. Note that the outer electrode 85 may be directly fixed to the electrode 133a, and the outer electrode 95 may be directly fixed to the electrode 133b.

Furthermore, the electrode holder 137 is provided with holders 29 and 30 configured the same as the holders 27 and 28. One end of the dielectric pipe 81 is inserted into a hole 29a in the holder 29, which is the hole on the side facing the electrode holder 137, and one end of the dielectric pipe 91 is inserted into a hole 29b in the holder 29, which is the hole on the side facing the electrically insulating section 135. The one end of each of the dielectric pipes 81 and 91 is thus held by the holder 29. The other end of the dielectric pipe 81 is inserted into a hole, on the side facing the electrode holder 137, in the holder 30 that is not shown, and the other end of the dielectric pipe 91 is inserted into a hole, on the side facing the electrically insulating section 135, in the holder 30 that is not shown. The other end of each of the dielectric pipes 81 and 91 is thus held by the holder 30.

Ends of the inner electrodes 83 and 93 that are the ends on one side are electrically connected to each other via an inner electrode connector 33b configured the same as the inner electrode connector 33a. Note that the other ends of the inner electrodes 83 and 93 may also be electrically connected to each other via another inner electrode connector 33b. The other end of the outer electrode 85 is electrically connected to the electrode 133a via the electrode holder 137, and also electrically connected to the chamber 131 via the electrode holder 137 and the wiring 137a. The outer electrode 85, the electrode holder 137, the wiring 137a, and the chamber 131 have the ground potential. The other end of the outer electrode 95 is electrically connected to the electrode 133b.

FIG. 14 is a circuit diagram of an electric circuit in the chamber 131 according to the present embodiment. When the switch 143a is turned on, the charge accumulated in the charging capacitor is transferred to the peaking capacitor 31a, and at the same time, the voltage between the electrodes 133a and 133b increases. Furthermore, a voltage that is half the voltage across the space between the electrodes 133a and 133b is induced across each of the inner electrodes 63, 73, 83, and 93. Corona discharge therefore occurs in the vicinity of the dielectric pipe 61 and the first end portion 65a, in the vicinity of the dielectric pipe 71 and the second end portion 75a in the vicinity of the dielectric pipe 81 and the third end portion 85a, and in the vicinity of the dielectric pipe 91 and the fourth end portion 95a, so that ultraviolet light is radiated from each of the regions where the corona discharge occurs. When the laser gas between the electrodes 133a and 133b is irradiated with the ultraviolet light, the laser gas between the electrodes 133a and 133b is preliminarily ionized. Primary discharge then occurs between the electrodes 133a and 133b. As a result, an excimer is generated from the laser medium contained in the laser gas between the electrodes 133a and 133b, and emits light when dissociated.

### 4.2 Effects and Advantages

In the chamber 131 according to the present embodiment, the distance from the imaginary axis 50 to the third end portion 85a decreases as the outer electrode 85 extends from one end toward the other end in the Z direction. The distance from the imaginary axis 50 to the fourth end portion 95a increases as the outer electrode 95 extends from the one end toward the other end in the Z direction.

According to the configuration described above, at the imaginary axis 50, the intensity of the preliminary ionization caused by the preliminary ionization electrode 80, which increases as the outer electrode 85 extends from the one end toward the other end in the Z direction, and the intensity of the preliminary ionization caused by the preliminary ionization electrode 90, which decreases as the outer electrode 95 extends from the one end toward the other end in the Z direction, are further added to the existing preliminary ionization intensity. The nonuniformity in the preliminary ionization intensity at the imaginary axis 50 can therefore be further suppressed, so that a decrease in the stability of the energy of the laser light output from the gas laser apparatus 100 can be further suppressed.

In the chamber 131, the direction in which the third end portion 85a extends inclines with respect to the imaginary axis 50 by the same angle by which the direction in which the fourth end portion 95a extends inclines in the opposite orientation to the inclination of the direction in which the fourth end portion 95a extends, and the third distance L3 is equal to the fourth distance L4.

In the configuration described above, when viewed along the Y direction, the third end portion 85a and the fourth end portion 95a are disposed symmetrically with respect to the respective centers thereof, and when viewed along the X direction, the third end portion 85a and the fourth end portion 95a are disposed in parallel to each other. The nonuniformity in the preliminary ionization intensity at the imaginary axis 50 can therefore be further suppressed, so that a decrease in the stability of the energy of the laser light output from the gas laser apparatus 100 can be further suppressed.

In the chamber 131, when viewed along the Y direction, the direction in which the third end portion 85a extends is parallel to the direction in which the first end portion 65a extends, and the direction in which the fourth end portion 95a extends is parallel to the direction in which the second end portion 75a extends.

According to the configuration described above, nonuniformity in the preliminary ionization intensity at the imaginary axis 50 can be further suppressed than in the case where the direction in which the first end portion 65a extends is not parallel to the direction in which the third end portion 85a extends. Furthermore, the nonuniformity in the preliminary ionization intensity at the imaginary axis 50 can be further suppressed than in the case where the direction in which the second end portion 75a extends is not parallel to the direction in which the fourth end portion 95a extends. A decrease in the stability of the energy of the laser light output from the gas laser apparatus 100 can therefore be further suppressed. Note that when viewed along the Y direction, the direction in which the third end portion 85a extends may not be parallel to the direction in which the first end portion 65a extends, and the direction in which the fourth end portion 95a extends may not be parallel to the direction in which the second end portion 75a extends.

FIG. 15 shows the preliminary ionization electrodes 80 and 90 and therearound shown in a variation of the present embodiment as viewed along the Z direction, and FIG. 16 shows the preliminary ionization electrodes 80 and 90 and therearound shown in FIG. 15 as viewed along the X direction.

In the present variation, the orientations of the inclination of the end portions 65a, 75a, 85a, and 95a differ from those in the second embodiment. Note that the orientations of the inclination of the end portions 65a and 75a in the present variation are the same as those in the variation of the first embodiment, and will therefore not be described.

In the present variation, when viewed along the Y direction, the dielectric pipe 81, the outer electrode 85, and the third end portion 85a coincide with the dielectric pipe 91, the outer electrode 95, and the fourth end portion 95a, and are not shifted therefrom. Furthermore, in the present variation, the direction in which the third end portion 85a extends and the direction in which the fourth end portion 95a extends incline toward the same side in the Y direction with respect to the imaginary axis 50 when viewed along the X direction. Specifically, the third end portion 85a approaches the imaginary axis 50 as extending from one end toward the other end in the Z direction, and the fourth end portion 95a separates away from the imaginary axis 50 as extending from the one end toward the other end in the Z direction. The thus disposed third end portion 85a and fourth end portion 95a extend in parallel to each other. The distance from the imaginary axis 50 to the third end portion 85a therefore decreases as the outer electrode 85 extends from the one end toward the other end in the Z direction. The distance from the imaginary axis 50 to the fourth end portion 95a increases as the outer electrode 95 extends from the one end toward the other end in the Z direction. Furthermore, when viewed along the X direction, the direction in which the third end portion 85a extends and the direction in which the first end portion 65a extends incline in opposite orientations in the Y direction with respect to the imaginary axis 50 so that the third end portion 85a intersects with the first end portion 65a. Moreover, the direction in which the fourth end portion 95a extends and the direction in which the second end portion 75a extends incline in opposite orientations in the Y direction with respect to the imaginary axis 50 so that the fourth end portion 95a intersects with the second end portion 75a.

In the present variation, when viewed along the X direction, the direction in which the first end portion 65a extends is parallel to the direction in which the second end portion 75a extends, and the direction in which the third end portion 85a extends is parallel to the direction in which the fourth end portion 95a extends. According to the configuration described above, nonuniformity of the preliminary ionization intensity at the imaginary axis 50 can be more suppressed than in the case where the direction in which the first end portion 65a extends is not parallel to the direction in which the second end portion 75a extends and the direction in which the third end portion 85a extends is not parallel to the direction in which the fourth end portion 95a extends. A decrease in the stability of the energy of the laser light output from the gas laser apparatus 100 can therefore be further suppressed. Note that when viewed along the X direction, the direction in which the third end portion 85a extends may be not parallel to the direction in which the fourth end portion 95a extends. Furthermore, when viewed along the Y direction, the direction in which the third end portion 85a extends may deviate from the direction in which the fourth end portion 95a extends.

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious for those skilled in the art that embodiments of the present disclosure would be appropriately combined.

The terms used throughout the present specification and the appended claims should be interpreted as non-limiting terms. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more”. Further, “at least one of A, B, and C” should be interpreted to mean any of A, B, C, A+B, A+C, B+C, and A+B+C as well as to include combinations of any thereof and any other than A, B, and C.

What is claimed is:

1. A chamber of a gas laser apparatus, the chamber encapsulating a laser gas in an internal space thereof and comprising:
first and second primary electrodes that are provided in the internal space, each have a longitudinal direction along a predetermined direction, face each other with a gap therebetween, and cause the laser gas to generate light by using a voltage applied to the electrodes,
a window that is provided at a wall surface of the chamber and transmits the light;
a first preliminary ionization electrode provided at one side of the first primary electrode; and
a second preliminary ionization electrode provided at the one side of the second primary electrode at a position where the second preliminary ionization electrode faces the first preliminary ionization electrode,
the first preliminary ionization electrode including a first dielectric pipe, a first preliminary ionization inner electrode that is disposed inside the first dielectric pipe and extends along a longitudinal direction of the first dielectric pipe, and a first preliminary ionization outer electrode that extends along the longitudinal direction of the first dielectric pipe and includes a first end portion that faces the first dielectric pipe,
the second preliminary ionization electrode including a second dielectric pipe, a second preliminary ionization inner electrode that is disposed inside the second dielectric pipe and extends along a longitudinal direction of the second dielectric pipe, and a second preliminary ionization outer electrode that extends along the longitudinal direction of the second dielectric pipe and includes a second end portion that faces the second dielectric pipe,
a distance from an imaginary axis extending along the predetermined direction between the first and second primary electrodes to the first end portion increasing from one side toward the other side in the predetermined direction, and
a distance from the imaginary axis to the second end portion decreasing from the one side toward the other side in the predetermined direction.

2. The chamber of a gas laser apparatus according to claim 1,
wherein the first and second preliminary ionization electrodes are disposed upstream in the laser gas flowing between the first and second primary electrodes.

3. The chamber of a gas laser apparatus according to claim 1,
wherein the first preliminary ionization inner electrode is electrically connected to the second preliminary ionization inner electrode,
the first preliminary ionization outer electrode is electrically connected to the first primary electrode, and
the second preliminary ionization outer electrode is electrically connected to the second primary electrode.

4. The chamber of a gas laser apparatus according to claim 1,
wherein the first preliminary ionization outer electrode is fixed to the first primary electrode via a first spacer; and
the second preliminary ionization outer electrode is fixed to the second primary electrode via a second spacer.

5. The chamber of a gas laser apparatus according to claim 1,
wherein a direction in which the first end portion extends and a direction in which the second end portion extends incline in opposite orientations with respect to the imaginary axis so that the first and second end portions intersect with each other when viewed along a direction in which the first and second primary electrodes are arranged.

6. The chamber of a gas laser apparatus according to claim 5,
wherein the direction in which the first end portion extends inclines with respect to the imaginary axis by the same angle by which the direction in which the second end portion extends inclines with respect to the imaginary axis in an opposite orientation to the inclination of the direction in which the second end portion extends, and
a first distance from a center of the first end portion in a longitudinal direction of the first preliminary ionization outer electrode to the imaginary axis is equal to a second distance from a center of the second end portion in a longitudinal direction of the second preliminary ionization outer electrode to the imaginary axis.

7. The chamber of a gas laser apparatus according to claim 6,
wherein a repetition frequency of the light is equal to or higher than 2 kHz.

8. The chamber of a gas laser apparatus according to claim 1,
wherein a direction in which the first end portion extends and a direction in which the second end portion extends incline with respect to the imaginary axis toward the same side in a direction in which the first and second primary electrodes are arranged when viewed along a direction perpendicular to the predetermined direction and the direction in which the first and second primary electrodes are arranged.

9. The chamber of a gas laser apparatus according to claim 8,
wherein a repetition frequency of the light is equal to or higher than 2 kHz.

10. The chamber of a gas laser apparatus according to claim 1, further comprising:
a third preliminary ionization electrode provided at the other side of the first primary electrode; and
a fourth preliminary ionization electrode provided at the other side of the second primary electrode at a position where the fourth preliminary ionization electrode faces the third preliminary ionization electrode,
wherein the third preliminary ionization electrode includes a third dielectric pipe, a third preliminary ionization inner electrode that is disposed inside the third dielectric pipe and extends along a longitudinal direction of the third dielectric pipe, and a third preliminary ionization outer electrode that extends along the longitudinal direction of the third dielectric pipe and includes a third end portion that faces the third dielectric pipe,
the fourth preliminary ionization electrode includes a fourth dielectric pipe, a fourth preliminary ionization inner electrode that is disposed inside the fourth dielectric pipe and extends along a longitudinal direction of the fourth dielectric pipe, and a fourth preliminary ionization outer electrode that extends along the longitudinal direction of the fourth dielectric pipe and includes a fourth end portion that faces the fourth dielectric pipe,
a distance from the imaginary axis to the third end portion decreases from the one side toward the other side in the predetermined direction, and
a distance from the imaginary axis to the fourth end portion increases from the one side toward the other side in the predetermined direction.

11. The chamber of a gas laser apparatus according to claim 10,
wherein the third preliminary ionization inner electrode is electrically connected to the fourth preliminary ionization inner electrode,
the third preliminary ionization outer electrode is electrically connected to the first primary electrode, and
the fourth preliminary ionization outer electrode is electrically connected to the second primary electrode.

12. The chamber of a gas laser apparatus according to claim 10,
wherein the third preliminary ionization outer electrode is fixed to the first primary electrode via a third spacer; and
the fourth preliminary ionization outer electrode is fixed to the second primary electrode via a fourth spacer.

13. The chamber of a gas laser apparatus according to claim 10,
wherein a direction in which the third end portion extends and a direction in which the fourth end portion extends incline in opposite orientations with respect to the imaginary axis so that the third and fourth end portions intersect with each other when viewed along a direction in which the first and second primary electrodes are arranged.

14. The chamber of a gas laser apparatus according to claim 13,
wherein the direction in which the third end portion extends inclines with respect to the imaginary axis by the same angle by which the direction in which the fourth end portion extends inclines with respect to the imaginary axis in an opposite orientation to the inclination of the direction in which the fourth end portion extends, and
a third distance from a center of the third end portion in a longitudinal direction of the third preliminary ionization outer electrode to the imaginary axis is equal to a fourth distance from a center of the fourth end portion in a longitudinal direction of the fourth preliminary ionization outer electrode to the imaginary axis.

15. The chamber of a gas laser apparatus according to claim 14,
wherein the angle is greater than or equal to 0.2 degrees but smaller than or equal to 3.0 degrees.

16. The chamber of a gas laser apparatus according to claim 14,
wherein the direction in which the third end portion extends is parallel to a direction in which the first end portion extends, and
the direction in which the fourth end portion extends is parallel to a direction in which the second end portion extends.

17. The chamber of a gas laser apparatus according to claim 10,
wherein a direction in which the third end portion extends and a direction in which the fourth end portion extends incline with respect to the imaginary axis toward the same side in a direction in which the first and second primary electrodes are arranged when viewed along a direction perpendicular to the predetermined direction and the direction in which the first and second primary electrodes are arranged.

18. The chamber of a gas laser apparatus according to claim 17,
wherein a direction in which the first end portion extends and a direction in which the second end portion extends incline with respect to the imaginary axis toward the same side in the direction in which the first and second primary electrodes are arranged and in an opposite orientation to the inclinations of the direction in which the third end portion extends and the direction in which the fourth end portion extends when viewed along the direction perpendicular to the predetermined direction and the direction in which the first and second primary electrodes are arranged.

19. The chamber of a gas laser apparatus according to claim 17,
wherein a direction in which the first end portion extends is parallel to a direction in which the second end portion extends, and
the direction in which the third end portion extends is parallel to the direction in which the fourth end portion extends.

20. An electronic device manufacturing method comprising:
generating laser light from a gas laser apparatus having a chamber that encapsulates a laser gas in an internal space thereof;
outputting the laser light to an exposure apparatus; and
exposing a photosensitive substrate with the laser light in the exposure apparatus to manufacture electronic devices,
the chamber including
first and second primary electrodes that are provided in the internal space, each have a longitudinal direction along a predetermined direction, face each other with a gap therebetween, and cause the laser gas to generate light by using a voltage applied to the electrodes,
a window that is provided at a wall surface of the chamber and transmits the light,
a first preliminary ionization electrode provided at one side of the first primary electrode, and
a second preliminary ionization electrode provided at the one side of the second primary electrode at a position where the second preliminary ionization electrode faces the first preliminary ionization electrode,
the first preliminary ionization electrode including a first dielectric pipe, a first preliminary ionization inner electrode that is disposed inside the first dielectric pipe and extends along a longitudinal direction of the first dielectric pipe, and a first preliminary ionization outer electrode that extends along the longitudinal direction of the first dielectric pipe and includes a first end portion that faces the first dielectric pipe,
the second preliminary ionization electrode including a second dielectric pipe, a second preliminary ionization inner electrode that is disposed inside the second dielectric pipe and extends along a longitudinal direction of the second dielectric pipe, and a second preliminary ionization outer electrode that extends along the longitudinal direction of the second dielectric pipe and includes a second end portion that faces the second dielectric pipe,
a distance from an imaginary axis extending along the predetermined direction between the first and second primary electrodes to the first end portion increasing from one side toward another side in the predetermined direction, and
a distance from the imaginary axis to the second end portion decreasing from
the one side toward the other side in the predetermined direction.
